(19) United States
(12) Patent Application Publication
(10) Pub. No.: US 2015/0269623 A1
(43) Pub. Date: Sep. 24, 2015

(54) SYSTEM AND METHOD FOR FORWARDING ADVERTISEMENT TO RECIPIENT ELECTRONIC DEVICE

(71) Applicant: Sony Corporation, Tokyo (JP)

(72) Inventor: Jonas ANDERSSON, Lund (SE)

(73) Assignee: Sony Corporation, Tokyo (JP)

(21) Appl. No.: 14/219,046

(22) Filed: Mar. 19, 2014

(51) Int. Cl. G06Q 30/02

(52) U.S. Cl. CPC G06Q 30/0267

(57) ABSTRACT

The present disclosure provides a system and method for forwarding an advertisement to a recipient electronic device. A call request may be sent to a server from an originating electronic device, the call request including an identity of the recipient electronic device. The server may generate a connection request including an identity of the originating electronic device and an advertisement. The server may send the connection request including the advertisement to the recipient electronic device. The connection request may be received at the recipient electronic device, and the notification of an incoming call may be displayed at a display of the recipient electronic device while the advertisement is presented at the recipient electronic device.

### TECHNICAL FIELD OF THE INVENTION

The technology of the present disclosure relates generally to electronic advertisements, and more particularly, to a system and method for forwarding an advertisement to a recipient electronic device.

### BACKGROUND

Mobile wireless electronic devices are becoming increasingly popular. For example, mobile telephones and tablets are now in wide-spread use. Many of these devices are highly integrated with the day-to-day happenings of a user, and as a result, present a promising avenue for providing advertisements to a user of the electronic device. However, many users find advertisements forwarded to their electronic device to be obtrusive and annoying.

### SUMMARY

The present disclosure provides a system and method for forwarding an advertisement (e.g., a recipient-targeted advertisement) to a recipient electronic device. In accordance with the present disclosure, an advertisement is provided to a recipient electronic device as part of a telephone call connection request. The connection request may be provided in response to a user of an originating electronic device placing an advertisement-included call. As a result of the advertisement being forwarded to the recipient user device with the connection request, at least a part of the duration of the call may not count against the contractual allotment of voice call minutes between the user of the originating electronic device and user's cellular service provider. Accordingly, the approach of the present disclosure may incentivize a user of an originating electronic device to place a call to a recipient electronic device including the advertisement. At the recipient electronic device, the advertisement may be integrated with the notification of the incoming call. Accordingly, from the perspective of the user of the recipient electronic device, the present disclosure provides an approach to forwarding the advertisement to the recipient electronic device in a less obtrusive manner.

According to one aspect of the disclosure, a method of forwarding an advertisement to a recipient electronic device includes receiving a call request from an originating electronic device, the call request including an identity of the recipient electronic device; generating a connection request, the connection request including an identity of the originating electronic device and an advertisement; and sending the connection request including the identity of the originating electronic device and the advertisement to the recipient electronic device.

The advertisement may include one or more of a picture advertisement, a video advertisement, or an audio advertisement.

Generating the connection request may include determining a content of the advertisement based on one or more of time, geographic location, user data of the originating electronic device, or user data of the recipient electronic device.

The content of the advertisement may be determined using the user data of the originating electronic device or the user data of the recipient electronic device, the user data of the originating electronic device or the user data of the recipient electronic device used in the determination being provided in the call request.

The content of the advertisement may be determined using the user data of the originating electronic device or the user data of the recipient electronic device, the user data of the originating electronic device or the user data of the recipient electronic device used in the determination being retrieved from a database separate from the originating electronic device.

Generating the connection request may include determining a content of the advertisement based on one or more criteria provided with the call request that indicates a type of advertisement to forward to the recipient electronic device.

Generating the connection request may include determining a content of the advertisement based on a call history of the recipient electronic device.

The call request may be received by a server of a cellular service provider of the originating electronic device, and the server of the cellular service provider may generate and send the connection request.

The method may further include receiving a connection response from the recipient electronic device; and establishing a call between the originating electronic device and the recipient electronic device, at least a part of a duration of the call not counting against a contractual allotment of voice call minutes between the originating electronic device and the cellular service provider.

According to another aspect of the disclosure, a server includes: a memory storing a call management function; and control circuitry that executes the call management function, the call management function being configured to: receive a call request from an originating electronic device, the call request including an identity of a recipient electronic device; generate a connection request, the connection request including an identity of the originating electronic device and an advertisement; and send the connection request including the identity of the originating electronic device and the advertisement to the recipient electronic device.

The advertisement may include one or more of a picture advertisement, a video advertisement, or an audio advertisement.

The call management function may be configured to determine a content of the advertisement based on one or more of time, geographic location, user data of the originating electronic device, or user data of the recipient electronic device.

The call management function may determine the content of the advertisement using the user data of the originating electronic device or the user data of the recipient electronic device, the user data of the originating electronic device or the user data of the recipient electronic device used in the determination being provided in the call request.

The call management function may determine the content of the advertisement using the user data of the originating electronic device or the user data of the recipient electronic device, the user data of the originating electronic device or the user data of the recipient electronic device used in the determination being retrieved from a database separate from the originating electronic device.

The call management function may determine a content of the advertisement based on or one or more criteria provided with the call request that indicates the type of advertisement to forward to the recipient electronic device.

The call management function may determine a content of the advertisement based on a call history of the recipient electronic device.

The server may be a server of a cellular service provider of the originating electronic device, and the server of the cellular service provider may receive the call request, generate the connection request, and send the connection request.

The call management function may be further configured to: receive a connection response from the recipient electronic device; and establish a call between the originating electronic device and the recipient electronic device, at least a part of a duration of the call not counting against a contractual allotment of voice call minutes between the originating electronic device and the cellular service provider.

According to yet another aspect of the disclosure, a method of presenting an advertisement at a recipient electronic device, including: receiving a connection request from a server, the connection request including an identity of an originating electronic device and an advertisement; and presenting a notification of an incoming call at a display of the recipient electronic device while also presenting the advertisement at the recipient electronic device.

The advertisement may include one or more of a picture advertisement, video advertisement, or audio advertisement.

The advertisement may be displayed on the display of the recipient electronic device together with the notification of the incoming call.

The advertisement displayed on the display of the recipient electronic device may be a user interactive advertisement.

The method may further include establishing a call between the originating electronic device and the recipient electronic device, wherein the advertisement is displayed on the display of the recipient electronic device throughout a duration of the call.

A content of the advertisement may be based on one or more of time, geographic location, user data of the originating electronic device, or user data of the recipient electronic device.

The method may further include storing the advertisement in a memory of the recipient electronic device.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

### BRIEF DESCRIPTION OF THE DRAWINGS

FIG. 1 is a schematic view of a mobile telephone as an exemplary electronic device.

FIG. 2 is a schematic block diagram of the exemplary electronic device of FIG. 1;

FIG. 3 is a schematic view of a communication system in which one or more electronic devices may operate;

FIGS. 4 and 5 are schematic views of exemplary user interfaces of electronic devices; and

FIG. 6 is a flow diagram representing an exemplary method of forwarding an advertisement to a recipient electronic device.

### DETAILED DESCRIPTION OF EMBODIMENTS

In the description that follows, like components have been given the same reference numerals, regardless of whether they are shown in different embodiments. To illustrate an embodiment(s) of the present invention in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

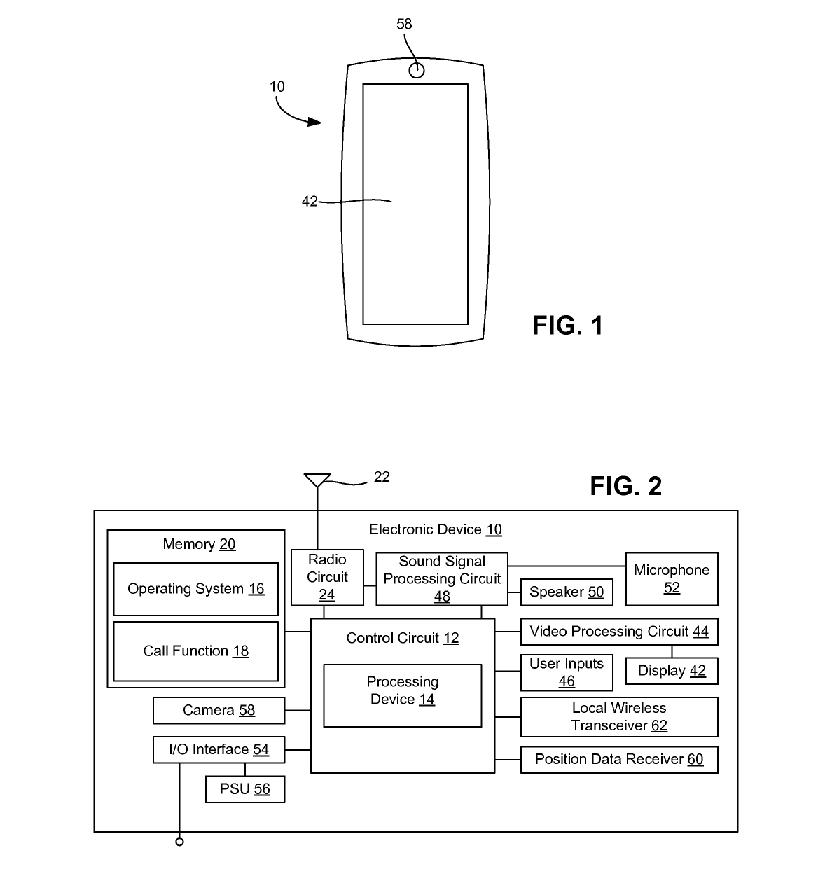

Referring initially to FIGS. 1 and 2, an electronic device is shown at 10. The electronic device of the illustrated embodiment is a mobile telephone and will be referred to as the electronic device 10. It will be appreciated that, while embodiments described herein are described primarily in the context of a portable radio communications device such as the illustrated mobile telephone, the exemplary context of a mobile telephone is not the only operational environment in which aspects of the disclosed systems and methods may be used. The techniques described in this document may be applied to any type of appropriate electronic device, examples of which include a mobile telephone, a tablet computing device, a media player, a gaming device, a laptop or desktop computer, a video telephone, an electronic organizer, a personal digital assistant (PDA), a multimedia device integrated in a vehicle, etc.

The electronic device 10 may include a control circuit 12 that is configured to carry out overall control of the functions and operations of the electronic device 10. The control circuit 12 may include a processing device 14, such as a central processing unit (CPU), microcontroller, or microprocessor. The processing device 14 executes code stored in a memory (not shown) within the control circuit 12 and/or in a separate memory, such as the memory 20, in order to carry out operation of the electronic device 10. For example, the processing device 14 may execute an operating system 16, the call function 18, and/or other applications. In the example shown, the operating system 16 and the call function 18 are stored on the memory 20. In other examples (not shown), the operating system 16 and/or the call function 18 may be stored in a memory within the control circuit 12.

The operating system 16 and/or the call function 18 may be embodied in the form of executable logic routines (e.g., lines of code, software programs, etc.) that are stored on a non-transitory computer readable medium (e.g., the memory 20) of the electronic device 10 and are executed by the control circuit 12 (e.g., using the processing device 14). Furthermore, the call function 18 may be a stand-alone software application or form a part of a software application (e.g., a part of the operating system 16) that carries out additional tasks related to the electronic device 10. Also, through the following description, exemplary techniques for forwarding an advertisement to a recipient electronic device are described. It will be appreciated that through the description of the exemplary techniques, a description of operations that may be carried out in part by executing software is described. The described operations may be considered a method that the corresponding device is configured to carry out. Also, while the call function 18 is implemented in software in accordance with an embodiment, such functionality could also be carried out via dedicated hardware or firmware, or some combination of hardware, firmware and/or software.

The operating system 16 may be executed by the processing device 14 to control the allocation and usage of resources in the electronic device 10, as well as provide basic user interface features. Specifically, the operating system 16 may control the allocation and usage of the memory 20, the processing time of the processing device 14 dedicated to various applications being executed by the processing device 14, as well as performing other functionality. In this manner, the operating system 16 may serve as the foundation on which applications, such as the call function 18, depend as is generally known by those with ordinary skill in the art. The operating system 16 also may control much of the user interface environment presented to a user, such as features of the overall graphical user interface (GUI) for the electronic device.

The call function 18 may be configured to place and/or receive telephone calls. As such, the call function 18 of the electronic device 10 may be used to establish communication with another electronic device (e.g., in a mobile communications system). In some embodiments, and as described in greater detail below, the electronic device may operate as an originating electronic device. Accordingly, the call function 18 of the electronic device 10 may be configured to generate and send a call request. In other embodiments, the electronic device may operate as a recipient electronic device. Accordingly, the call function 18 of the electronic device 10 may be configured to receive a connection request and send a connection response. The call function 18 of the electronic device 10 may also be configured to operate (e.g., with the display of the electronic device and/or the speaker of the electronic device) to present a notification of an incoming call together with the advertisement. Furthermore, the call function 18 of the electronic device 10 may be configured to store the advertisement on the electronic device 10 (e.g., on the memory 20). While the call function 18 is described herein as performing each of the above operations, it will be appreciated that the call function 18 may include one or more modules, each module configured to perform one or more dedicated functions. For example, while not specifically shown, the call function 18 may include a call request generation function to generate a call request; a call request sending function to send a call request to a server; a connection request receiving function to receive a connection request; a presentation function to present a notification of an incoming call together with the advertisement; a connection response sending function to send a connection response to the server; and/or an advertisement storage function to store the advertisement on the electronic device 10. Additional details and operation of the call function 18 will be described in greater detail below.

The memory 20 may be, for example, one or more of a buffer, a flash memory, a hard drive, a removable media, a volatile memory, a non-volatile memory, a random access memory (RAM), or other suitable device. In a typical arrangement, the memory 20 may include a non-volatile memory for long term data storage and a volatile memory that functions as system memory for the control circuit 12. The memory 20 may exchange data with the control circuit 12 over a data bus. Accompanying control lines and an address bus between the memory 20 and the control circuit 12 also may be present. The memory 20 is considered a non-transitory computer readable medium.

The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 20, executing applications to allow user interaction with the data, displaying video and/or image content associated with the data, outputting audio sounds associated with the data, and so forth.

In the exemplary embodiment, the communications circuitry may include an antenna 22 coupled to a radio circuit 24. The radio circuit 24 includes a radio frequency transmitter and receiver for transmitting and receiving signals via the antenna 22.

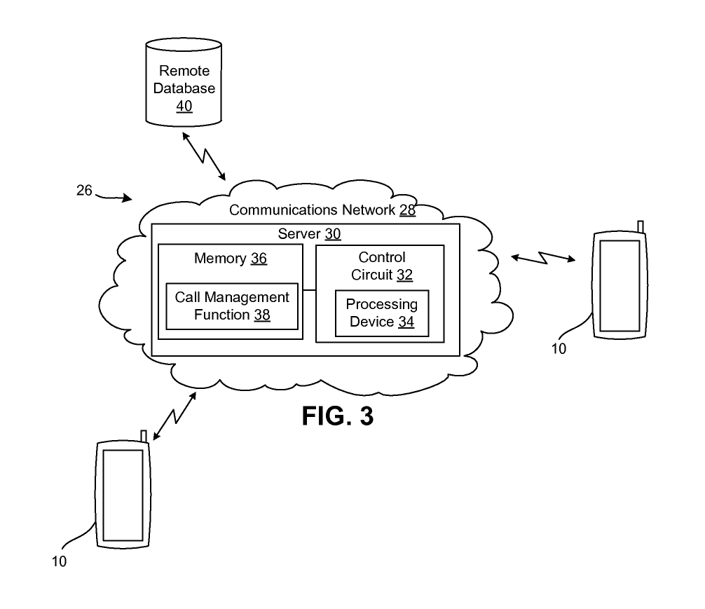

With additional reference to FIG. 3, the radio circuit 24 may be configured to operate in a mobile communications system 26. Radio circuit 24 types for interaction with a mobile radio network and/or broadcasting network include, but are not limited to, global system for mobile communications (GSM), code division multiple access (CDMA), wideband CDMA (WCDMA), general packet radio service (GPRS), long term evolution (LTE), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 22 and the radio circuit 24 may represent one or more than one radio transceiver.

The communications system 26 may include a communications network 28 having a server 30 (or servers) for managing calls placed by and destined to the electronic device 10, transmitting data to and receiving data from the electronic device 10 and carrying out any other support functions. The server 30 communicates with the electronic device 10 via a transmission medium. The transmission medium may be any appropriate device or assembly, including, for example, a communications base station (e.g., a cellular service tower, or “cell” tower), a wireless access point, a satellite, etc. The communications network 28 may support the communications activity of multiple electronic devices and other types of end user devices. The exemplary embodiment of the communications system 26 shown in FIG. 3 includes two electronic devices 10 connected to the communications network 28. In other embodiments, more than two electronic devices 10 and/or one or more other types of end user devices may be connected to the communications network 28.

In some embodiments, the server 30 may be embodied as a server of a user's cellular service provider. In other embodiments, the server 30 may be embodied as a server of a service provider that is independent from the user's cellular service provider.

As will be appreciated, the server 30 may be configured as a typical computer system used to carry out server functions. The server 30 may include a control circuit 32 that is configured to carry out overall control of the functions and operations of the server 30. The control circuit 32 may include a processing device 34, such as a central processing unit (CPU), microcontroller, or microprocessor. The processing device 34 executes code stored in a memory (not shown) within the control circuit 32 and/or in a separate memory, such as the memory 36, in order to carry out operation of the electronic device 10. For example, the processing device 34 may execute the call management function 38, and/or other applications. In the example shown, the call management function 38 is stored on the memory 36. In other examples (not shown), the call management function 38 may be stored in a memory within the control circuit 32.

The memory 36 may be, for example, one or more of a buffer, a flash memory, a hard drive, a removable media, a volatile memory, a non-volatile memory, a random access memory (RAM), or other suitable device. In a typical arrangement, the memory 36 may include a non-volatile memory for long term data storage and a volatile memory that functions as system memory for the control circuit 32. The memory 36 may exchange data with the control circuit 32 over a data bus. Accompanying control lines and an address bus between the memory 36 and the control circuit 32 also may be present. The memory 36 is considered a non-transitory computer readable medium.

The call management function 32 may be configured to manage calls between electronic devices (e.g., between an originating electronic device and a recipient electronic device). For example, the call management function 38 may be configured to receive a call request from an originating electronic device. The call management function 38 may also be configured to generate a connection request and send the connection request to a recipient electronic device. The connection request may include an advertisement, and the call management function may be configured to determine the content of the advertisement. Furthermore, the call management function 38 may be configured to receive a connection response from the recipient electronic device, and establish a call between the originating electronic device and the recipient electronic device.

While the call management function 38 is described herein as performing each of the above operations, it will be appreciated that the call management function 38 may include one or more modules, each module configured to perform one or more dedicated functions. For example, while not specifically shown, the call management function 38 may include a call request receipt function to receive a call request from an originating electronic device; a connection request generation function to generate a connection request; an advertisement determination function to determine the content of the recipient advertisement; a connection request sending function to send a connection request to a recipient electronic device; a connection response receipt function to receive a connection response from the recipient electronic device; and/or a call establishment function to establish a call between the originating electronic device and the recipient electronic device. Additional details and operation of the call management function 38 will be described in greater detail below.

In one embodiment, the call management function 38 may be embodied in the form of executable logic routines (e.g., lines of code, software programs, etc.) that are stored on a non-transitory computer readable medium (e.g., the memory 36) of the server 30 and are executed by the control circuit 32 (e.g., using the processing device 34). Furthermore, the call management function 38 may be a stand-alone software application or may form a part of a software application (e.g., a part of an operating system of the server) that carries out additional tasks related to server 30. Also, through the following description, exemplary techniques for forwarding an advertisement to a recipient electronic device are described. It will be appreciated that through the description of the exemplary techniques, a description of operations that may be carried out in part by executing software is described. The described operations may be considered a method that the server is configured to carry out. Also, while the call management function 38 is implemented in software in accordance with an embodiment, such functionality could also be carried out via dedicated hardware or firmware, or some combination of hardware, firmware and/or software.

The server 30 may be connected through the communications network 28 to one or more external devices. Such external devices may provide data that may be used by the server (e.g., by the call management function executed by the server) in connection with forwarding an advertisement to a recipient electronic device. For example, as shown in FIG. 3, a remote database 40 is connected to the server 30 through the communications network 28. The remote database 40 may store one or more advertisements that may be forwarded to a recipient electronic device, and/or information pertaining to the originating electronic device and/or the recipient electronic device.

With continued reference to FIGS. 1 and 2, the electronic device 10 may include a display 42. The display 42 displays information to a user such as operating state, time, telephone numbers, contact information, incoming call information, outgoing call information, various menus, etc., that enable the user to utilize the various features of the electronic device 10. The display 42 also may be used to visually display content received by the electronic device 10 and/or retrieved from a memory 20 (FIG. 2) of the electronic device 10. The display 42 may be used to present images, video, and other graphics to the user. In some embodiments, the display may be a backlit liquid-crystal display (LCD), an organic light-emitting diode (OLED) display, or another suitable type of display.

The display 42 may be coupled to the control circuit 12 by a video processing circuit 44 that converts video data to a video signal used to drive the display 42. The video processing circuit 44 may include any appropriate buffers, decoders, video data processors and so forth. The video data may be generated by the control circuit 12, retrieved from a video file that is stored in the memory 20, derived from an incoming video data stream that is received by the radio circuit 24, or obtained by any other suitable method.

The electronic device 10 may include one or more user inputs 46 for receiving user input for controlling operation of the electronic device 10. Exemplary user inputs 46 include, but are not limited to, a touch input that overlays the display 42 for touch screen functionality, one or more buttons, motion sensors (e.g., gyro sensors, accelerometers), and so forth.

The electronic device 10 may further include a sound signal processing circuit 48 for processing audio signals. Coupled to the sound signal processing circuit 48 are a speaker 50 and a microphone 52 that enable a user to listen and speak via the electronic device 10, and hear sounds generated in connection with other functions of the device 10. The sound signal processing circuit 48 is coupled to the control circuit 12 so as to carry out overall operation. Audio data may be passed from the control circuit 12 to the sound signal processing circuit 48 for playback to the user. The sound signal processing circuit 48 may include any appropriate buffers, decoders, encoders, amplifiers and so forth.

The electronic device 10 may further include one or more input/output (I/O) interface(s) 54. The I/O interface(s) 54 may be in the form of typical mobile telephone I/O interfaces and may include one or more electrical connectors. The I/O interfaces 54 may form one or more data ports for connecting the electronic device 10 to another device (e.g., a computer) or an accessory (e.g., a headset) via a cable. Further, operating power may be received over the I/O interface(s) 54 and power to charge a battery of a power supply unit (PSU) 56 within the electronic device 10 may be received over the I/O interface(s) 54. The PSU 56 may supply power to operate the electronic device 10 in the absence of an external power source.

The electronic device 10 also may include various other components. For instance, a camera 58 may be present for taking digital pictures and/or movies. Image and/or video files corresponding to the pictures and/or movies may be stored in the memory 20. A position data receiver 60, such as a global positioning system (GPS) receiver, Galileo satellite system receiver or the like, may be involved in determining the location of the electronic device 10. A local transceiver 62, such as an infrared transceiver and/or an RF transceiver (e.g., a Bluetooth chipset) may be used to establish communication with a nearby device, such as an accessory (e.g., a headset), another mobile radio terminal, a computer or another device.

As described above, the call function 18 of the electronic device 10 may be configured to place and/or receive telephone calls. Hence, the call function 18 of the electronic device 10 may be used to establish communication with another electronic device (e.g., through the communications network 28).

In some embodiments, the electronic device 10 may operate as an originating electronic device by placing the telephone call. As such, the call function 18 of the electronic device 10 may be configured to generate a call request. The call request may include information for establishing communication with a recipient electronic device and/or for use in determining an appropriate advertisement to forward to the recipient electronic device. For example, the call request may include information pertaining to the recipient electronic device (e.g., the telephone number of the recipient electronic device). The call request may also include identification information of the originating electronic device (e.g., the telephone number of the originating electronic device). In some embodiments, the call request may include biographic data of one or more of the user of the recipient electronic device or the user of the originating electronic device (e.g., the name of the user, the gender of the user, the age of the user, interests of the user, etc.). Such information may be entered by the user of the originating electronic device in advance of the call request.

In some embodiments, the call request may include one or more criteria elected by the user of the originating electronic device that indicates the type of advertisement to forward to the recipient electronic device. For example, the user may be prompted (e.g., by the call function 18) to choose a type of advertisement that is to be forwarded (e.g., an advertisement for a restaurant, and advertisement for a bar, a political advertisement, an advertisement for an event, and advertisement for an attraction, etc.) By providing such information, the user of the originating electronic device may find the process of placing an advertisement-included call more appealing, as the user may choose the type of advertisement to be forwarded.

The call function 18 of the electronic device 10 may be configured to send the call request to the server 30. The call request may be sent through the communications network 28.

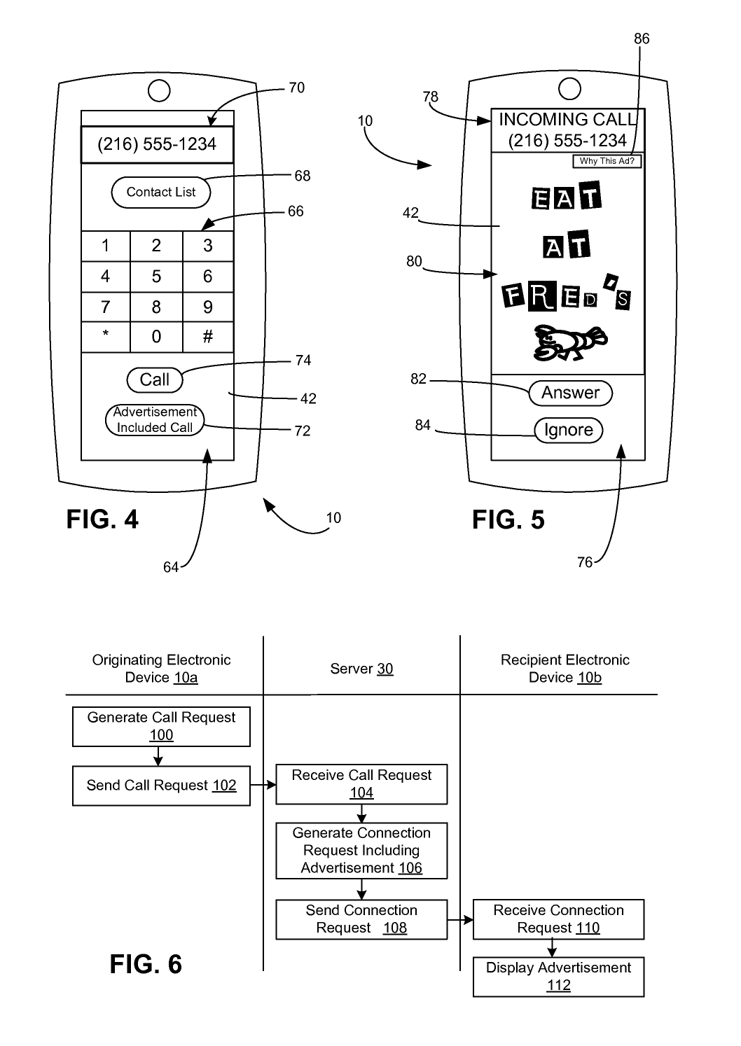

Generating and sending the call request may be performed in response to a user command performed at the originating electronic device. FIG. 4 shows an exemplary user interface 64 displayed on the display 42 of an electronic device 10 by which the user of the originating electronic device may input a command to place an advertisement-included call to a recipient electronic device. The user may interact with the interface 64 displayed on the display 42 using a touch screen overlaid on the display 42. In the example shown, the interface 64 includes a keypad 66 by which the user may enter the number of a recipient electronic device, and a contact list button 68 that may allow the user to select a number stored in a contact list. A telephone entered or selected may be displayed in display area 70 for visual confirmation by the user. In some embodiments (e.g., where a contact is selected from the contact list or where a number entered by the user matches a number stored in the contact list), the display area 70 may additionally or alternatively display a name associated with the number. The interface also includes an advertisement-included call button 72 and a conventional call button 74. The user of the originating electronic device may initiate the generation of and sending of the call request by selecting the advertisement included call button 72. As an alternative, the user may establish a conventional telephone call using the call button 74. Hence, in the exemplary embodiment shown, the interface provides the user with an option for placing an advertisement-included call, and for placing a conventional telephone call that does not include an advertisement.

In some embodiments, the electronic device 10 may operate as a recipient electronic device by receiving the telephone call. As such, the call function 18 of the electronic device 10 may be configured to receive a connection request (e.g., the connection request being sent by the server 30 to the electronic device as a result of an originating electronic device attempting to establish connection with the electronic device). The connection request may include the identity of the originating electronic device (e.g., the telephone number of the originating electronic device), and may include an advertisement. The advertisement may include one or more of a picture advertisement, a video advertisement, or an audio advertisement. The call function 18 of the electronic device 10 may operate to integrate the presentation of the advertisement at the recipient electronic device with the notification of the incoming call.

FIG. 5 shows an exemplary user interface 76 displayed on the display 42 of an electronic device that includes the advertisement integrated with the notification of the incoming call. The user may interact with the interface 76 using a touch screen overlaid on the display 42. In the example shown, the interface 76 includes a caller display area 78 to display the identity of the originating electronic device. In the exemplary embodiment, the number of the originating electronic device is displayed in the caller display area. In other embodiments (e.g., where the number matches a number stored in the contact list of the recipient electronic device), the caller display area 78 may additionally or alternatively display a name associated with the number. The interface 76 also includes an advertisement display area 80 to display the advertisement. In the exemplary embodiment, the advertisement is a picture. The interface includes an answer button 82, an ignore button 84, and an inquiry button 86. The user may answer the telephone call by selecting the answer button 82. The user may ignore the telephone call by selecting the ignore button 84. The user may find out more information regarding the advertisement by selecting the inquiry button 86. In the exemplary embodiment, selection of the inquiry button 86 may allow a user of the recipient electronic device to find out information regarding why the advertisement is included with the incoming call. This presents the opportunity to generate awareness regarding the ability to place such calls. In other examples, the inquiry button 86 may provide details pertaining to the advertisement itself.

In some examples, the user of the recipient electronic device may be able to interact with the advertisement. For example, the advertisement may be embodied as a selectable link that opens a webpage in a browser. With exemplary reference to the embodiment shown in FIG. 5, selecting the advertisement of the restaurant may open the restaurant's website in a browser of the electronic device. The user may then be able to browse information such as menu selections and specials. In other examples, selection of the advertisement may prompt the server 30 to provide the recipient electronic device with additional information pertaining to the advertisement (e.g., directions, coupons, etc.)

The call function 18 of the electronic device 10 may be configured to display the advertisement throughout the duration of the call. In some embodiments, the call function 18 may also be configured to display the advertisement for a defined period of time following the telephone call. This may enable the user of the recipient electronic device to read and/or interact with the advertisement following the call.

The call function 18 of the electronic device 10 may be configured to store the advertisement on the electronic device 10 (e.g., on the memory 20). By storing the advertisement, the user of the recipient electronic device may view and/or use the advertisement at a time following the call. For example, the advertisement may also function as a coupon and/or may include information such as location, time, etc. that the user may use at a later time. In some embodiments (not shown), the interface 76 may provide the user with the option of saving the advertisement to the electronic device. Accordingly, the user of the recipient electronic device may save only those advertisements that the user deems interesting or useful. In other embodiments, the advertisement may be automatically saved to the electronic device. In some implementations, the user of the electronic device may access the stored advertisements by accessing a call log stored on the electronic device. By viewing a recent call, the advertisement forwarded with the call may also be viewed. In other implementations, the user of the electronic device may access the stored advertisements by selecting a separate application via the user interface.

The call function 18 of the electronic device 10 may be configured to send a connection response to the server 30. The connection response may dictate the establishment of the telephone call between the originating electronic device and the recipient electronic device. For example, accepting the incoming call at the recipient electronic device may result in establishment of the telephone call. As another example, ignoring the incoming call at the recipient electronic device may not result in the establishment of the telephone call and may instead direct the originating electronic device to the voicemail of the recipient electronic device.

As described above, the call management function 38 of the server 30 may be configured to manage calls between the originating electronic device and the recipient electronic device. For example, the call management function 38 may be configured to receive a call request from an originating electronic device. In response to the call request, the call management function 38 may generate a connection request. The connection request may include the identity of the originating electronic device (e.g., the telephone number of the originating electronic device) and the advertisement.

In generating the connection request, the call management function 38 of the server 30 may be configured to determine the content of the advertisement to be sent to the recipient electronic device. The advertisement may be one or more of a picture advertisement, a video advertisement, or an audio advertisement. The server 30 may store (e.g., on the memory 36) or may have access to (e.g., on the remote database 40 through the communications network 28) a multitude of advertisements. In embodiments where the advertisement is stored on a remote database, generation of the connection request may include the request and receipt of the advertisement from the external database 40.

Advertisers may pay a fee (e.g., a flat fee or a per use fee) to have their advertisements included among the multitude of advertisements. In some embodiments, the fee paid by the advertiser (e.g., a flat fee) may be unrelated to a fee for the call placed by the user of the originating electronic device. In other embodiments, the fee paid by the advertiser (e.g., a per use fee) may be more closely tied to the fee for the call. Accordingly, the call management function 38 may operate as a broker between the user of the originating electronic device and the advertiser.

In determining the content of the advertisement, the call management function 38 may select an advertisement from among the multitude of advertisements. The advertisement may be selected based on one or more factors in order to tailor the advertisement to the user of the recipient electronic device. Accordingly, the selected advertisement may also be referred to as a recipient-targeted advertisement.

In some embodiments, the call management function 38 of the server may determine the content of the advertisement (e.g., the recipient-targeted advertisement) based on one or more of time (e.g., time of day, time of year, etc.), geographic location (e.g., of the recipient electronic device or of the originating electronic device), information pertaining to the user of the originating electronic device and/or the user of the recipient electronic device (e.g., gender, age, interests, etc.), and/or one or more criteria elected by the user of the originating electronic device that indicates the type of advertisement to forward to the recipient electronic device. Such information may be included as a part of the call request, and/or may be retrieved from a database stored on the server 30 or external database 40 (e.g., stored in advance of the call request.

For example, if time of day is taken into consideration in making the determination, an advertisement for a restaurant may be selected if the call request is received during a time of day customarily associated with breakfast, lunch, or dinner (e.g., as shown in FIG. 5). As another example, if geographic location is taken into consideration in making the determination, an advertisement for a local business may be selected that is geographically located near to the recipient electronic device (e.g., as may be determined using the area code of the recipient electronic device). As another example, if information pertaining to the user of the recipient electronic device is taken into consideration, an advertisement for a store directed to a male clothing store may be selected if it is known that the user of the recipient electronic device is male. As another example, if one or more criteria elected by the user of the originating electronic device is taken into consideration, an advertisement for a local restaurant may be selected if it is determined that the elected criteria is for a restaurant. Of course, in other examples, multiple criteria may be used in determining the content of the advertisement.

In addition or as an alternative to the above, the call management function 38 of the server 30 may determine the content of the advertisement, at least in part, based on advertiser preference. In those embodiments where advertisers may pay to have their advertisements included as the advertisement, some advertisers may pay more in order to increase the frequency of use of their advertisement as the advertisement.

In addition or as an alternative to the above, a user's call history may be a factor in the call management function 38 determining the content of the advertisement. For example, the call management function 38 may keep a log of recent calls sent to the recipient electronic device, and may keep track of the advertisements forwarded to the recipient electronic device in connection with those calls. The call management function 38 may use such information to ensure that the same advertisement is not sent to the recipient electronic device more than once for a given period of time (e.g., within a time period of 1 hour, ½ hour, or another suitable period of time).

The call management function 38 of the server 30 may be configured to send the connection request to the recipient electronic device. The call request may be sent through the communications network 28. Furthermore, the call management function 38 may be configured to receive a connection response from the recipient electronic device. Based on the connection response, the call management function 38 may be configured to establish a call between the originating electronic device and the recipient electronic device.

The features of the call function and the call management function are exemplified in FIG. 6, which shows logical operations for implementing an exemplary method of forwarding an advertisement to a recipient electronic device. In the example, the originating electronic device is identified as 10a, and the recipient electronic device is identified as 10b. The exemplary method may be carried out by executing embodiments of the call function 18 and/or embodiments of the call management function 38, for example. Although FIG. 6 shows a specific order of logical operations, the order thereof may be changed relative to the order shown. Also, two or more logical operations shown in succession may be executed concurrently or with partial concurrence. Certain logical operations also may be omitted.

The logical flow may begin at 100 where the call function 18 of the originating electronic device 10a generates a call request. Generation of the call request is performed as a result of the user of the originating electronic device 10a dialing the number of a recipient electronic device 10b and entering a command to call the recipient electronic device 10b. For example, with reference to FIG. 4, the user of the originating electronic device may interact with the interface 64 by entering the number of the recipient electronic device 10b using the keypad 66, and by entering a command to place an advertisement-included call by pressing button 72.

In the example, the call request includes the number of the recipient electronic device and the number of the originating electronic device. In other examples, the call request may additionally include biographic data of one or more of the user of the recipient electronic device or the user of the originating electronic device (e.g., the name of the user, the gender of the user, the age of the user, interests of the user, etc.).

At 102, the call function 18 of the originating electronic device 10a sends the call request to the server. The call request is sent through the communications network 28. The call request is received by the server at 104.

At 106, the call management function 38 of the server 30 generates the connection request. The connection request includes the number of the originating electronic device and the advertisement. Furthermore, in the example, the content of the advertisement is determined based on the time of day at which the call request is received. Accordingly, an advertisement is to be selected that is applicable to the time at which the call request is received by the server. For example, an advertisement for a restaurant may be selected if the call request is received during a time of day customarily associated with lunch. In other examples, the content of the advertisement is determined on other or additional criteria (e.g., geographic location, information pertaining to the user of the electronic device, and/or advertiser preference).

At 108, the connection request is sent to the recipient electronic device 10b. The call request is sent through the communications network 28. The connection request is received by the recipient electronic device 10b at 110.

At 112, the advertisement is presented using the recipient electronic device 10b. For example, with reference to FIG. 5, the advertisement is displayed in the advertisement display area 80 of the interface 76. The advertisement is presented together with the information pertaining to the incoming call.

The system and method of the present disclosure provides an approach to forwarding an advertisement to the recipient electronic device in a more effective and less obtrusive manner. By integrating the advertisement with the incoming call, the user of the recipient electronic device may be more likely to see and/or hear the advertisement when viewing the identity of the caller. Furthermore, because the advertisement is integrated with the display of the incoming call, the advertisement is likely to be regarded as less obtrusive as compared with simply forwarding an advertisement to the recipient electronic device.

The system and method of the present disclosure also may incentivize the use of an advertisement-included call from the side of the originating electronic device. For example, as a result of the advertisement being forwarded to the recipient electronic device with the connection request, at least a part of the duration of the call may not count against the contractual allotment of voice call minutes between the user of the originating electronic device and user's cellular service provider. In embodiments where the cellular service provider of the user of the originating electronic device incorporates the system and method of the present disclosure, inclusion of the advertisement may be applied as payment for all or for a portion of the call. For example, the service provider may consider the inclusion of the advertisement as payment for up to a given number of minutes for the call. In embodiments where the server is embodied as a server of a service provider that is independent from the user's cellular service provider, use of this alternative service prevents the user of the originating electronic device from having to use his or her minutes for the call.

Although certain embodiments have been shown and described, it is understood that equivalents and modifications falling within the scope of the appended claims will occur to others who are skilled in the art upon the reading and understanding of this specification.

What is claimed is:

1. A method of forwarding an advertisement to a recipient electronic device, comprising:
receiving a call request from an originating electronic device, the call request comprising an identity of the recipient electronic device;
generating a connection request, the connection request comprising an identity of the originating electronic device and an advertisement; and
sending the connection request comprising the identity of the originating electronic device and the advertisement to the recipient electronic device.

2. The method of claim 1, wherein the advertisement comprises one or more of a picture advertisement, a video advertisement, or an audio advertisement.

3. The method of claim 1, wherein generating the connection request comprises determining a content of the advertisement based on one or more of time, geographic location, user data of the originating electronic device, or user data of the recipient electronic device.

4. The method of claim 1, wherein generating the connection request comprises determining a content of the advertisement based on one or more criteria provided with the call request that indicates a type of advertisement to forward to the recipient electronic device.

5. The method of claim 1, wherein generating the connection request comprises determining a content of the advertisement based on a call history of the recipient electronic device.

6. The method of claim 1, wherein the call request is received by a server of a cellular service provider of the originating electronic device, and the server of the cellular service provider generates and sends the connection request.

7. The method of claim 6, further comprising:
receiving a connection response from the recipient electronic device; and
establishing a call between the originating electronic device and the recipient electronic device, at least a part of a duration of the call not counting against a contractual allotment of voice call minutes between the originating electronic device and the cellular service provider.

8. A server, comprising:
a memory storing a call management function; and
control circuitry that executes the call management function, the call management function being configured to:
receive a call request from an originating electronic device, the call request comprising an identity of a recipient electronic device;
generate a connection request, the connection request comprising an identity of the originating electronic device and an advertisement; and
send the connection request comprising the identity of the originating electronic device and the advertisement to the recipient electronic device.

9. The server of claim 8, wherein the advertisement comprises one or more of a picture advertisement, a video advertisement, or an audio advertisement.

10. The server of claim 8, wherein the call management function is configured to determine a content of the advertisement based on one or more of time, geographic location, user data of the originating electronic device, or user data of the recipient electronic device.

11. The server of claim 8, wherein the call management function is configured to determine a content of the advertisement based on or one or more criteria provided with the call request that indicates a type of advertisement to forward to the recipient electronic device.

12. The server of claim 8, wherein the call management function is configured to determine a content of the advertisement based on a call history of the recipient electronic device.

13. The server of claim 8, wherein the server is a server of a cellular service provider of the originating electronic device, and the server of the cellular service provider receives the call request, generates the connection request, and sends the connection request.

14. The server of claim 13, wherein the call management function is further configured to:
receive a connection response from the recipient electronic device; and
establish a call between the originating electronic device and the recipient electronic device, at least a part of a duration of the call not counting against a contractual allotment of voice call minutes between the originating electronic device and the cellular service provider.

15. A method of presenting an advertisement at a recipient electronic device, comprising:
receiving a connection request from a server, the connection request comprising an identity of an originating electronic device and an advertisement; and
presenting a notification of an incoming call at a display of the recipient electronic device while also presenting the advertisement at the recipient electronic device.

16. The method of claim 15, wherein the advertisement comprises one or more of a picture advertisement, video advertisement, or audio advertisement.

17. The method of claim 15, wherein the advertisement is displayed on the display of the recipient electronic device together with the notification of the incoming call.

18. The method of claim 17, wherein the advertisement displayed on the display of the recipient electronic device is a user interactive advertisement.

19. The method of claim 15, further comprising establishing a call between the originating electronic device and the recipient electronic device, wherein the advertisement is displayed on the display of the recipient electronic device throughout a duration of the call.

20. The method of claim 15, further comprising storing the advertisement in a memory of the recipient electronic device.
